(19) United States
(12) Patent Application Publication
(10) Pub. No.: US 2003/0059761 A1
(43) Pub. Date: Mar. 27, 2003

(54) On-line homework solution system

(76) Inventor: Pamela Patterson, S.J. Capistrano, CA (US)

Correspondence Address: KLEIN, O'NEILL & SINGH, 2 PARK PLAZA, SUITE 510, IRVINE, CA, 92614, US

(21) Appl. No.: 09/960,817

(22) Filed: Sep. 21, 2001

(51) Int. Cl. G09B 3/00

(52) U.S. Cl. 434/332

(57) ABSTRACT

A program for assigning and correcting homework on-line based upon the authorization of and feedback from users. The program includes various parts, including a homework assignment portion, a student tutorial portion and various review and grading portions for use by authorized users. After a homework assignment is completed by an authorized student, the homework is automatically reviewed and entered into a grade book. The student may be required to redo the assignment if certain criteria are not met. Stored grades may also be reviewed or compared to other grades entered in the system. Authorized users may also receive various e-mails and/or reports generated by the system regarding speed of comprehension, areas of comprehension, areas where comprehension is lacking, grade status, class standing and behavioral/citizenship status.

### BACKGROUND OF THE INVENTION

1. Field of the Invention

This invention relates generally to studying, and more particularly, to the use of an on-line network website for controlled interaction between students, teachers, schools and parents to improve the effectiveness of study by providing real-time feedback and access to homework, homework assignments, grade status, behavioral/citizenship status, and other information and reports.

2. Description of Related Art

Currently, homework is assigned to students by educators, such as teachers or teachers assistants, and the students assigned the homework are responsible for doing the homework and turning it in to the educator. The homework is then presumably graded and returned to the student, although in some cases the homework is not graded nor returned. In any case, the feedback to the student is either substantially delayed or nonexistent and, as a result, the student's ability to learn from doing the homework is greatly impaired or entirely missing.

Furthermore, regular parental or guardian assistance or supervision of students doing homework is usually difficult or non-existent. Therefore, if the students do not, or cannot, do the homework, all parties involved suffer.

Attempts have been made to improve this process, but none of the known homework methods provide acceptable or adequate solutions to all parties. Therefore, there exists a need in the art for a homework system that can be accessed by authorized parties, to provide improved student comprehension and test scores and to advise parents and teachers of students' homework status and results.

### SUMMARY OF THE INVENTION

Accordingly, it is a general object of the present invention to provide an on-line homework system. It is a particular object of the present invention to provide an on-line homework performance and management system to aid in improving student comprehension and test scores. It is another particular object of the present invention to provide an improved on-line homework system that allows the submission of input from a number of different parties. It is yet another particular object of the present invention to provide an improved on-line homework system that reduces the workload of teachers, school and parents in administering and grading the learning process. It is yet a further particular object of the present invention to provide an improved online homework system that focuses a student's time on his/her areas of least comprehension. It is yet a still further particular object of the present invention to provide an improved on-line homework system that allows a teacher or assistant to load and automatically track the results of homework assignments for students. It is a still further particular object of the present invention to provide an improved on-line homework system that enables authorized users, such as parents, to track the learning process of their children. And, it is yet another further particular object of the present invention to provide an improved on-line homework system that allows grade status, behavioral/citizenship status and accurate and sophisticated reports on students to be generated and sent to or accessed by authorized users.

According to one aspect of the present invention, there is provided a system whereby users may access a website over the internet, and upon approval, enter homework assignments, allow students to complete homework and/or practice for tests, and provide parents and teachers, as well as other to authorized users, with progress reports and grades. Additionally, the present invention further provides for authorized users to receive status and other reports.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, wherein:

FIG. 1 is a screenshot of one embodiment of the software of the present invention; and

FIGS. 2-2C are block diagrams of a preferred embodiment of a homework solution of the present invention.

### DETAILED DESCRIPTION OF THE PREFERRED EMBODIMENT

The following description is provided to enable any person skilled in the art to make and use the invention and sets forth the best modes contemplated by the inventor of carrying out her invention. Various modifications, however, will remain readily apparent to those skilled in the art, since the generic principles of the present invention have been defined herein, specifically to provide for an on-line based homework solution program or system, generally indicated at 10.

Using the program of the present invention, homework assignments, including the homework itself are made available on-line at a website, for example, one referred to as www.IHaveHomework.com (IHH). Teachers (T), school officials (SCH), school district officials (SD), parents (P) and students (ST), as well as other approved persons, such as Textbook Companies (TB), are provided access to the system, as by assigning them a password or the like. Teachers or teachers assistants, using assigned passwords, enter homework assignments or assign questions or other material provided or entered into the system by Textbook Companies, related school information, etc. onto a selected portion of the website. Parents and students, who also have assigned passwords, can then view daily, or at other predetermined increments, what has been assigned, when due, schedules of upcoming tests and other related school information. Students can then practice and/or complete and submit their assignments on-line and, depending on what options are available, receive feedback immediately, or within a predetermined time period. The program can also tutor the student and retest the student on any missed portion of an assignment. This tutorial process may continue until the student attains a full understanding of the assignment. Parents and teachers are notified via e-mail of any continuing failure to understand, thereby empowering both the parents and the teachers to give the students more focused attention. This ensures that students, after successfully completing the homework assignments, have a comprehensive understanding of the covered subjects. This in turn, better prepares students for school tests.

Because the program allows students to both practice and complete homework on-line, teachers no longer have to spend valuable time managing whether homework was completed and returned, grading homework papers and booking grades or scores. The program automatically grades the homework and keeps track of each student's grades or scores. Thus, the teachers may spend more time working directly with students, preparing lesson plans, and becoming even more effective teachers.

Parent supervision of homework is made much easier since parents now have a tool that allows them to view and be alerted as to what has been assigned to their children (typically via e-mail), when assignments are due, whether assignments have been turned in, how their children are performing, when upcoming exams are scheduled, etc.

The program can also provide progress reports to advise parents and teachers whether all the homework for a given day has been completed. Furthermore, the parent will have on-going access to the student's grades on the website, as well as summaries of what assignments have or have not been completed. This should eliminate surprises for everyone, particularly at report card time, and gives parents, teachers and students the ability to correct students' work habits before they can significantly affect their comprehension and grades.

By using the program of the present invention, better student performance and higher test scores are achieved through at least two key features. Immediate feedback to students as they learn increases their comprehension of study materials by effectively providing one-on-one review and testing on-line. Students' study time is focused on areas of greatest need, and they learn more because they are challenged with material they have not yet mastered. Furthermore, parents can get feedback at anytime, thereby being in a position to provide positive reinforcement and to focus their efforts on a student's greatest area of need. Thus parents are enabled to help their children to prepare sufficiently for their exams.

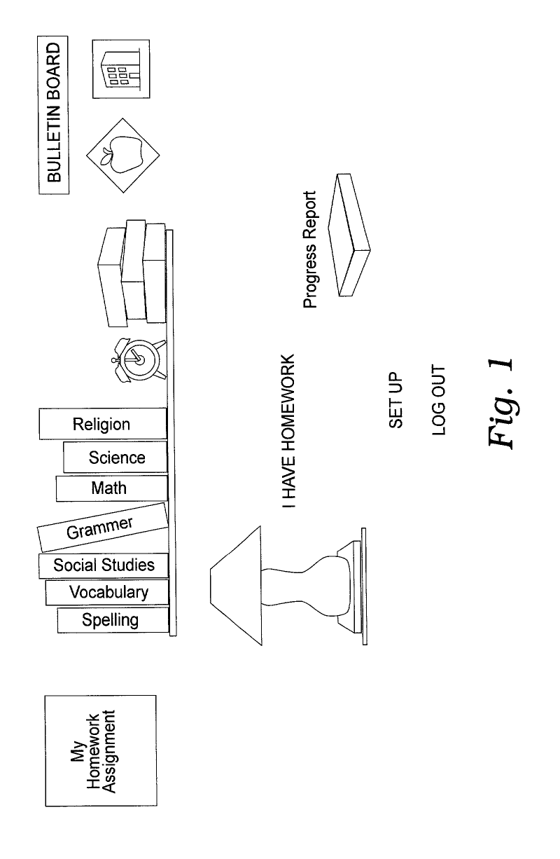

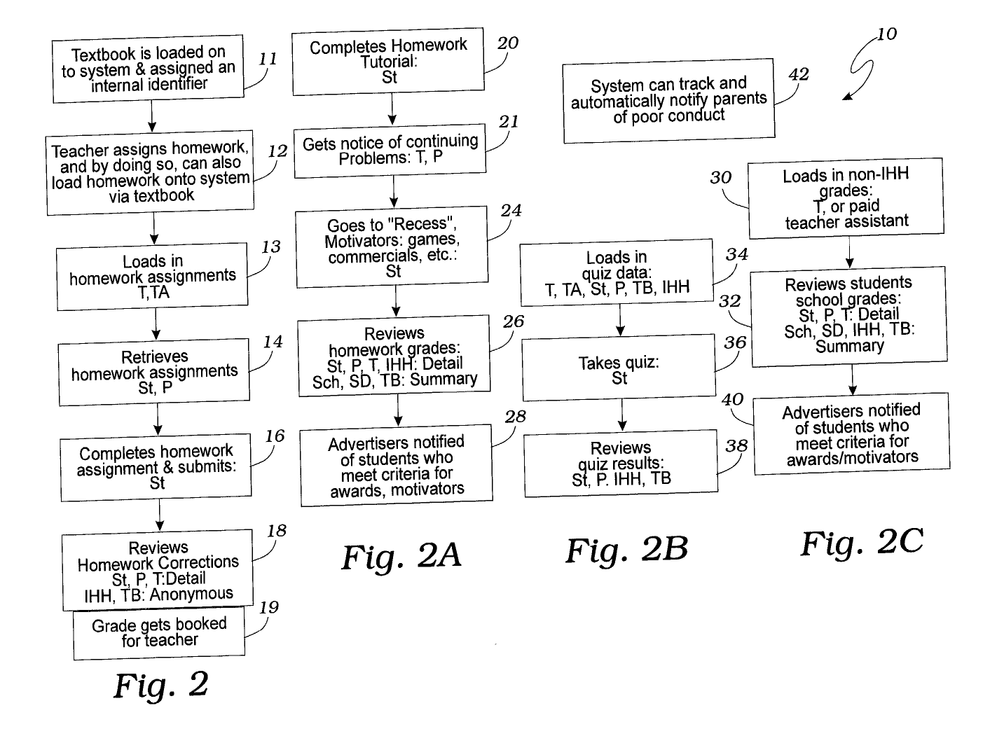

Referring now to the screen of FIG. 1 and block diagrams of FIGS. 2-2C, specific examples of how the invention may be utilized are given by way of explanation and not limitation. The website shown in FIG. 1 may be accessed by authorized persons over the internet, or another on-line system. For example, a textbook or other information is loaded onto the system and assigned an internal identifier at 11. A teacher (T) or teacher's assistant (TA) assigns homework and by so doing also loads it into the system on the website (IHH) at 12, 13. The parent (P) or a student (ST) may retrieve the homework assignment at 14. The student may then complete a homework assignment and submit it at 16. Authorized persons may review the students' homework (ST, P, T), or anonymous information (TB) or website operator (IHH) at 18. Students grades get booked for teacher at 19. Alternatively, the student may complete a homework tutorial to correct mistakes at 20, and an e-mail or other announcement may be sent to (T) or (P) regarding problems with a homework tutorial by the student at 21.

Various homework assignments may also be loaded onto the website by any authorized personnel (T, TA, TB, SCH, SD, IHH). After the student completes the homework assignment at 16, the completed homework is automatically graded by the system and booked for the teacher at 19. The results are immediately returned to the student and the student tutored and requizzed at 20 on any missed problems until the student has attained 100% accuracy or has been requizzed a specified number of times, such as three, for example, whichever comes first. Since the teacher and the parent are automatically e-mailed regarding any continuing failure to comprehend by the student, they can more easily follow-up with the student. The student may go to recess at 22 and the grades may be reviewed by authorized personnel (ST, P, T, TB, SCH, SD) at 34.

The website may also perform a number of other functions, such as notifying various interested parties, including advertisers, honor societies, or the like, of how students compare to certain criteria at 28. Additionally, grades of students not having access to the website, or manual grades for classwork, or the like may be entered into a database on the website at 30. All grades, whether originally in the IHH or manually entered may then be reviewed at 32, or compared to those of other students.

In addition to homework assignments, “pop” or other type quizzes may be entered at 34, taken by students at 36 and reviewed at 38. The students may then go to “recess” similar to 24, while waiting for reviews or progress reports and at any time, advertisers or the like may be notified regarding students meeting award criteria at 28 or 40.

The present invention may also be used to generate all types of e-mails and/or reports for teachers, parents, school officials and the like, such as behavioral/citizenship status at 42. The behavioral/citizen status reports may be based on a predetermined list of criteria, which may be continuously updated by authorized personnel (T, SCH, SD), contained in a separate database on the website.

Finally, various grade reports, student comparisons and class standings may be generated for teachers, schools and school districts, as needed.

Those skilled in the art will appreciate that there are adaptations and modifications of the just-described preferred embodiments that can be configured without departing from the scope and spirit of the invention. Therefore, it is to be understood, that within the scope of the intended claims, the invention may be practiced other than is specifically described herein.

What is claimed is:

1. A method for providing on-line studying, grading and reporting, comprising the steps of:
maintaining a homework solution and grading database accessible to authorized users;
providing on-line access to a homework assignment tutorial and completion website containing the homework solution and grading database;
allowing authorized users to select between a variety of assignments and reports at the website; and
providing means for the website to automatically e-mail selected information to authorized users.

2. The method of claim 1, further comprising the step of providing means for a student to complete a homework assignment.

3. The method of claim 2, further including means for automatically grading homework and booking the grades of students.

4. The method of claim 3, further including the step of automatically advising selected persons of students and how they compare to certain criteria.

5. The method of claim 1, further including means to allow manual grades to be entered into the website.

6. The method of claim 5, further including means for reviewing and comparing student grades.

7. The method of claim 1, further including the step of loading further data onto the website.

8. The method of claim 7 wherein the further data may be accessed by authorized students for completion.

9. The method of claim 8 wherein the completed further data is reviewed and graded.

10. The method of claim 1, further including the step of providing means for a student to perform a homework assignment, and for reperforming the homework assignments until 100% correct or a predetermined number of times.

11. A method for providing on-line studying, grading and reporting, comprising the steps of:
maintaining a homework solution and grading database accessible to authorized users;
providing on-line access to a homework assignment tutorial and completion website containing the homework solution and grading database;
allowing authorized users to select between a variety of assignments and reports at the website;
providing means for a student to complete a homework assignment;
means for automatically grading homework and booking the grades of students; and
providing means for the website to automatically e-mail selected information to authorized users.

12. The method of claim 11, further including the step of automatically advising selected persons of students and how they compare to certain criteria.

13. The method of claim 11, further including the step of providing means for a student to perform a homework assignment, and for reperforming the homework assignments until 100% correct or a predetermined number of times.

14. A method for providing on-line studying, grading and reporting, comprising the steps of:
maintaining a homework solution and grading database accessible to authorized users;
providing on-line access to a homework assignment tutorial and completion website containing the homework solution and grading database;
allowing authorized users to select between a variety of assignments and reports;
providing means for a student to complete a homework assignment on the website;
providing means for automatically grading homework and booking the grades of students on the website;
advising selected persons of students and how they compare to certain criteria; and
providing means for the website to automatically e-mail selected information to authorized users.

15. The method of claim 14, further including the step of providing means for a student to perform a homework assignment, and for reperforming the homework assignments until 100% correct or a predetermined number of times.
